(19) United States
(12) Patent Application Publication
(10) Pub. No.: US 2014/0224223 A1
(43) Pub. Date: Aug. 14, 2014

(54) SYSTEM AND METHOD FOR DETERMINING INJECTED FUEL QUANTITY BASED ON DRAIN FUEL FLOW

(71) Applicant: CUMMINS INC., Columbus, IN (US)

(72) Inventors: Donald J. BENSON, Columbus, IN (US); Daniel E. ARONHALT, Elizabethtown, IN (US); David M. CAREY, Greenwood, IN (US); Sanjay MANGLAM, Franklin, IN (US); Hisham K. MOZAFFAR, Indianapolis, IN (US); Eric BENHAM, Seymour, IN (US); Paul PEAVLER, Columbus, IN (US)

(73) Assignee: CUMMINS INC., Columbus, IN (US)

(21) Appl. No.: 13/763,528

(22) Filed: Feb. 8, 2013

(51) Int. Cl. F02D 41/32

(52) U.S. Cl. CPC F02D 41/32
USPC 123/478

(57) ABSTRACT

A system and method is provided for controlling the amount of fuel delivered during an injection event by measuring the drain fuel flow from a valve that controls the injection event.

### TECHNICAL FIELD

This disclosure relates to a system and method for determining an amount or quantity of fuel delivered during an injection event by measuring an amount or quantity of drain fuel flow from a valve that controls the fuel injection event.

### BACKGROUND

As with all mechanical devices, fuel injectors have physical dimensions that lead to variations between fuel injectors. Since the fuel delivered by each fuel injector during a fuel injection event varies enough to affect the performance of an associated engine, it is useful to measure or calculate the fuel delivery by each fuel injector. However, directly measuring fuel delivery is difficult and complicated and present methods of calculating or estimating fuel delivered can require significant processing capability and have significant noise and estimation errors.

### SUMMARY

This disclosure provides a method of controlling an amount of fuel injected by a fuel injector of an internal combustion engine. The method comprises providing a fuel quantity relationship between the amount of fuel injected by the fuel injector and an amount of drain fuel flow from the fuel injector, and providing the fuel quantity relationship to a control system of the engine. The method further comprises determining the amount of drain fuel flow for an injection event, and controlling the amount of fuel injected by the fuel injector based on the determined drain fuel flow using the fuel quantity relationship.

This disclosure also provides a method of determining an amount of fuel injected by a fuel injector of an internal combustion engine. The method comprises predefining a fuel quantity relationship between an amount of a drain fuel flow of the fuel injector and the corresponding amount of fuel injected by the fuel injector, and providing the fuel quantity relationship to a control system of the engine. The method further comprises determining the amount of drain fuel flow for an injection event, and controlling the amount of fuel injected by the fuel injector based on the determined drain fuel flow using the fuel quantity relationship.

This disclosure also provides a system for controlling an amount of fuel injected by a fuel injector of an internal combustion engine, comprising a controller, a fuel injector control valve, and a flow-measuring device. The controller is adapted to generate an injection control signal and includes a non-transitory computer-readable medium. The non-transitory computer-readable medium includes a fuel quantity relationship between the amount of fuel injected by the fuel injector and an amount of drain fuel flow from the fuel injector. The fuel injector control valve has an open position and a closed position, and is adapted to receive the injection control signal. The flow-measuring device is adapted to transmit a drain flow signal to the controller that is indicative of the amount of drain fuel flow. The controller is adapted to receive the drain flow signal and to transmit the injection control signal to the fuel injector control valve to move the fuel injector control valve from the open position to the closed position when the drain fuel flow correlates to a desired amount of fuel injected based on the fuel quantity relationship.

Advantages and features of the embodiments of this disclosure will become more apparent from the following detailed description of exemplary embodiments when viewed in conjunction with the accompanying drawings.

### BRIEF DESCRIPTION OF THE DRAWINGS

FIG. 1 is a schematic of an internal combustion engine.

FIG. 2 is a schematic of a test fixture in accordance with an exemplary embodiment of the present disclosure.

FIG. 3 is a graph showing an exemplary fuel quantity relationship between a valve drain fuel flow and an injected quantity of fuel acquired from the test fixture of FIG. 2.

FIG. 4 is a schematic of a first exemplary embodiment of the present disclosure that may be incorporated in the engine of FIG. 1.

FIG. 5 is a schematic of a second exemplary embodiment of the present disclosure that may be incorporated in the engine of FIG. 1.

### DETAILED DESCRIPTION

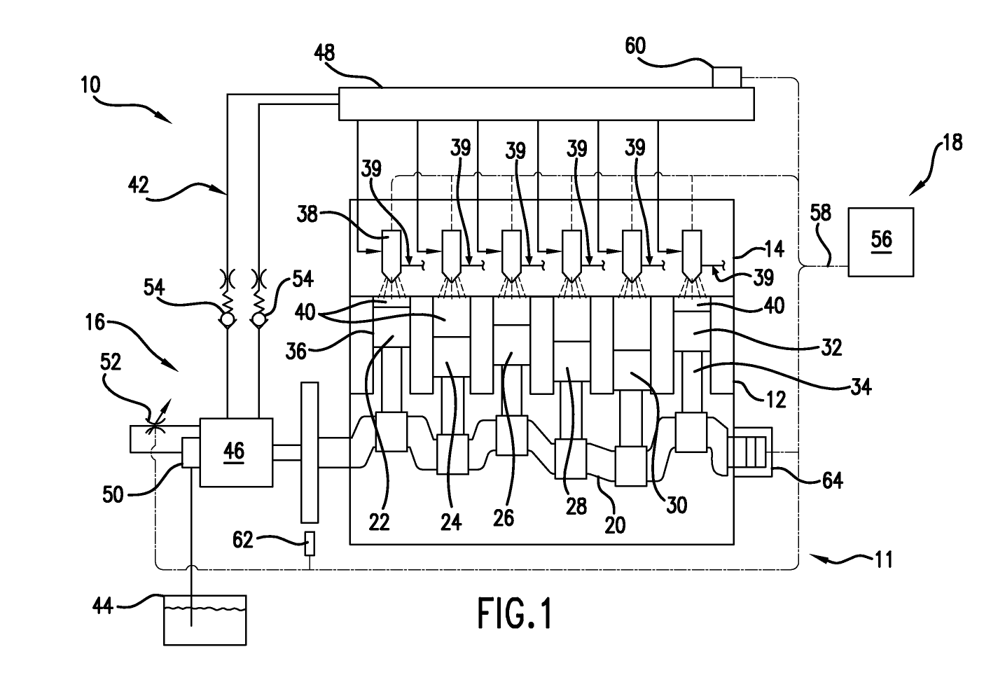

Referring to FIG. 1, a portion of a conventional internal combustion engine is shown as a simplified schematic and generally indicated at 10. Engine 10 may be any engine type, including inline, straight, and “V” configurations. Engine 10 includes an engine body 11, which includes an engine block 12 and a cylinder head 14 attached to engine block 12, a fuel system 16, and a control system 18. Control system 18 receives operational inputs or signals from sensors located on engine 10 and transmits control signals to devices located on engine 10 to control the function of those devices, such as one or more fuel injectors.

One challenge with fuel injectors is that they have a measure of variability from injector to injector, even with the same injection control signal, leading to a variation in fuel quantity delivered during an injection event. The variation in fuel quantity delivered causes undesirable variations in output power in engine 10 and causes undesirable variation in emissions, e.g., NOₓ and CO. In order to combat these undesirable effects, techniques of measuring fuel delivery by each fuel injector have been developed. However, directly measuring fuel delivery is difficult and complicated, and calculating or estimating fuel delivered using present techniques, which uses a pressure drop in a fuel accumulator associated with the fuel injector, can require significant processing capability and has significant noise and estimation errors. The system and method of the present disclosure provides an improved measurement of fuel injected that minimizes processing requirements and uses relatively inexpensive hardware to provide an accurate estimate of the quantity of fuel delivered by a fuel injector. This estimate provides fuel delivered on an absolute basis, meaning that actual quantity is measured or determined rather than using a relative measurement, such as a pressure differential in a fuel accumulator. The ability to estimate the quantity of fuel delivered accurately by a fuel injector independent of variations between fuel injectors decreases power variations, improves emissions performance, and provides an ability to accommodate fuel injector design changes since the engine uses drain fuel flow information to control fuel delivery, which is measured or calculated with any design changes. The ability to measured quantity of fuel delivered also permits compensating for variations between injectors and compensating for variations in operation, thus creating an adaptive control system that minimizes the difference between a commanded injected quantity and the injected quantity estimated from the drain flow. This compensation may be made either by providing a feedback signal that engine 10 uses to modify fuel delivery for a future injection event, or by monitoring an injection event in real time, terminating the injection event when the appropriate amount of fuel is delivered. Because engine 10 is able to estimate fuel delivery using a relationship between drain flow and fuel delivered, injector trim codes, which are often used to provide individual fuel injector calibrations, are rendered unnecessary, simplifying the process of testing and assembling fuel injectors into an engine.

The present disclosure presents other advantages. For example, because an engine is able to determine whether a particular fuel injector is providing a commanded amount of fuel, the engine is able to use the system and method of the present disclosure as a fuel injector diagnostic. When the ability to compensate for fuel flow exceeds a predetermined limit, the engine may determine that a fuel injector is failing prior to such a failure becoming catastrophic, which may reduce warranty costs. In addition, the system and method of the present disclosure provides improved reporting of fuel consumption as compared to engines where fuel consumption is monitored by way of inferred fuel consumption using indirect measurements, such as a pressure drop in a fuel accumulator. Yet another advantage may be improved or enhanced compatibility with automatic transmissions, as absolute fueling measurements permits matching the operation of the engine with the operation of the automatic transmission.

Engine body 12 includes a crankshaft 20, a #1 piston 22, a #2 piston 24, a #3 piston 26, a #4 piston 28, a #5 piston 30, a #6 piston 32, and a plurality of connecting rods 34. Pistons 22, 24, 26, 28, 30, and 32 are positioned for reciprocal movement in a plurality of engine cylinders 36, with one piston positioned in each engine cylinder 36. One connecting rod 34 connects each piston to crank shaft 20. As will be seen, the movement of the pistons under the action of a combustion process in engine 10 causes connecting rods 34 to move crankshaft 20. While engine 10 is shown having six cylinders, engine 10 may include any number of cylinders from a single cylinder to multiple cylinders. In the exemplary embodiment, engine 10 includes six cylinders arranged in an inline configuration. However, engine 10 may include any number of cylinders, such as one, two, four, six, twelve, etc., arranged in a variety of configurations, including inline, straight and “V.”

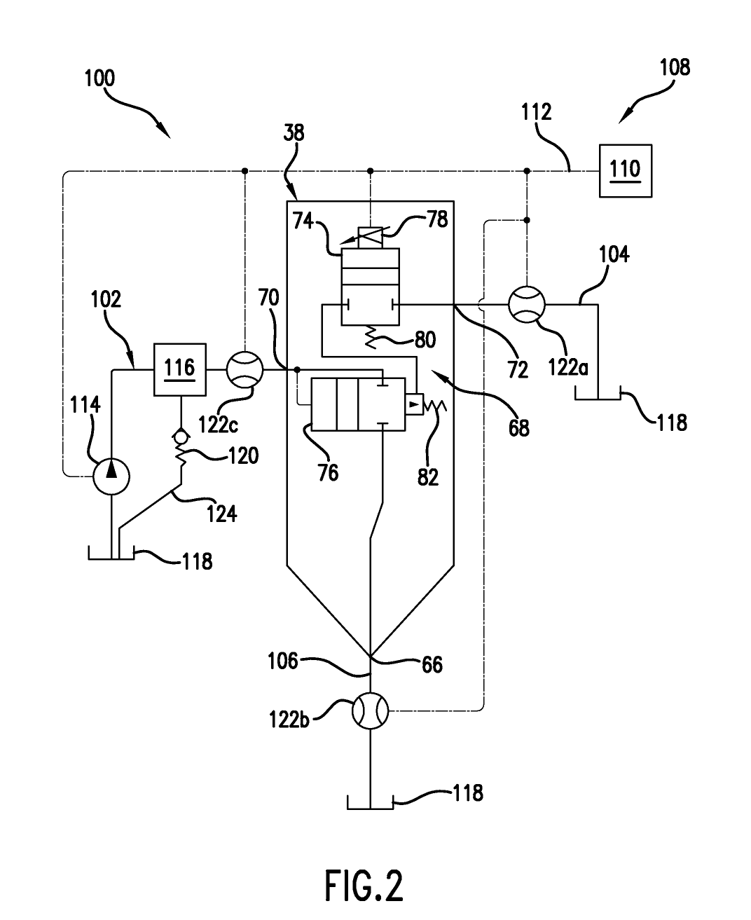

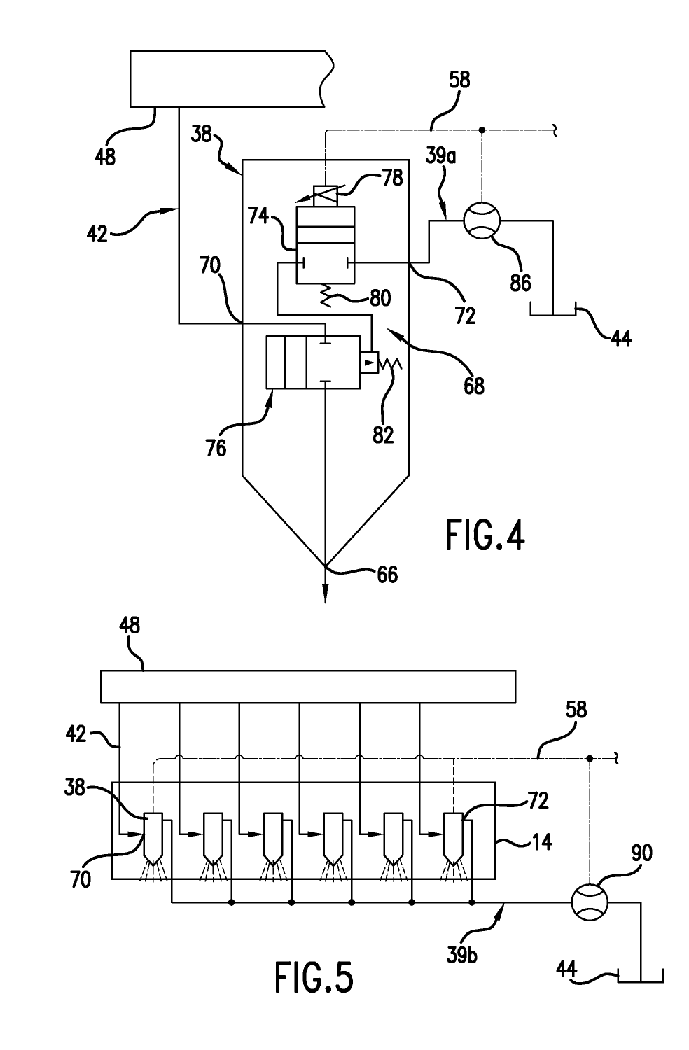

In an exemplary embodiment, a plurality of fuel injectors 38 is positioned within cylinder head 14. Each fuel injector 38 includes one or more injector orifices 66, shown schematically in FIGS. 2 and 4, that fluidly connect a respective fuel injector 38 to a combustion chamber 40, each of which is formed by one piston, cylinder head 14, and the portion of engine cylinder 36 that extends between the piston and cylinder head 14.

Fuel system 16 provides fuel to injectors 38, which is then injected into combustion chambers 40 by the action of fuel injectors 38. Fuel injector 38 may include a nozzle valve or needle valve element (not shown) that moves from a closed position to an open position and then from the open position to the closed position, forming an injection event. The nozzle or needle valve element may move from the closed position to the open position when fuel injector 38 is energized by control system 18 to inject fuel through the injector orifices 66 into combustion chamber 40 during an injection event. When fuel injector 38 is energized, a drain fuel flow may flow from fuel injector 38 into a drain fuel circuit portion 39, which returns the drain fuel flow to a location where the drain fuel may be used by engine 10, such as fuel tank 44. The nozzle or needle valve element remains open for a time period, called the on-time, that provides a predetermined volume, amount, or quantity of fuel to combustion chamber 40, as determined by control system 18 based on operation state inputs, such as acceleration and torque or power. At the end of the predetermined time period, control system 18 de-energizes fuel injector 38, which causes the nozzle or needle valve element to close, ending the injection event. While the nozzle or needle valve element is described as opening when energized and closing when de-energized, fuel injector 38 may also operate in an opposite manner where the nozzle or needle valve element opens when de-energized and closes when energized. Fuel injector 38 may be similar to the fuel injectors disclosed in U.S. Pat. Nos. 6,253,736 and 8,201,543, which are hereby incorporated by reference in their entirety. Fuel system 16 includes a fuel circuit 42, a fuel tank 44 containing a fuel, a high-pressure fuel pump 46 positioned along fuel circuit 42 downstream from fuel tank 44, and a fuel accumulator or rail 48 positioned along fuel circuit 42 downstream from high-pressure fuel pump 46. While fuel accumulator or rail 48 is shown as a single unit or element in the exemplary embodiment, accumulator 48 may be distributed over a plurality of elements that contain high-pressure fuel. These elements may include fuel injector(s) 38, high-pressure fuel pump 46, and any lines, passages, tubes, hoses and the like that connect high-pressure fuel to the plurality of elements, and a separate fuel accumulator 48 may thus be unnecessary. Fuel system 16 also includes an inlet metering valve 52 positioned along fuel circuit 42 upstream from high-pressure fuel pump 46 and one or more outlet check valves 54 positioned along fuel circuit 42 downstream from high-pressure fuel pump 46 to permit one-way fuel flow from high-pressure fuel pump 46 to fuel accumulator 48. Fuel circuit 42 connects fuel accumulator 48 to fuel injectors 38, which receive fuel from fuel circuit 42 and then provide controlled amounts of fuel to combustion chambers 40. Fuel system 16 may also include a low-pressure fuel pump 50 positioned along fuel circuit 42 between fuel tank 44 and high-pressure fuel pump 46. Low-pressure fuel pump 50 increases the fuel pressure to a first pressure level prior to fuel flowing into high-pressure fuel pump 46, which increases the efficiency of operation of high-pressure fuel pump 46.

Control system 18 may include a control module 56 and a wire harness 58. Many aspects of the disclosure are described in terms of sequences of actions to be performed by elements of a computer system or other hardware capable of executing programmed instructions, for example, a general-purpose computer, special purpose computer, workstation, or other programmable data process apparatus. It will be recognized that in each of the embodiments, the various actions could be performed by specialized circuits (e.g., discrete logic gates interconnected to perform a specialized function), by program instructions (software), such as program modules, being executed by one or more processors (e.g., one or more microprocessors, a central processing unit (CPU), and/or application specific integrated circuit), or by a combination of both. For example, embodiments can be implemented in hardware, software, firmware, microcode, or any combination thereof. The instructions can be program code or code segments that perform necessary tasks and can be stored in a non-transitory machine-readable medium such as a storage medium or other storage(s). A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents.

The non-transitory machine-readable medium can additionally be considered to be embodied within any tangible form of computer readable carrier, such as solid-state memory, magnetic disk, and optical disk containing an appropriate set of computer instructions, such as program modules, and data structures that would cause a processor to carry out the techniques described herein. A computer-readable medium may include the following: an electrical connection having one or more wires, magnetic disk storage, magnetic cassettes, magnetic tape or other magnetic storage devices, a portable computer diskette, a random access memory (RAM), a read-only memory (ROM), an erasable programmable read-only memory (e.g., EPROM, EEPROM, or Flash memory), or any other tangible medium capable of storing information.

Thus, the various aspects of the disclosure may be embodied in many different forms, and all such forms are contemplated to be within the scope of the disclosure.

Control system 18 may also include an accumulator pressure sensor 60 and a crank angle sensor. While sensor 60 is described as being a pressure sensor, sensor 60 may be other devices that may be calibrated to provide a pressure signal that represents fuel pressure, such as a force transducer, strain gauge, or other device. The crank angle sensor may be a toothed wheel sensor 62, a rotary Hall sensor 64, or other type of device capable of measuring the rotational angle of crankshaft 20. Control system 18 uses signals received from accumulator pressure sensor 60 and the crank angle sensor to determine the combustion chamber receiving fuel, which may then be used to analyze the signals received from accumulator pressure sensor 60.

Control module 56 may be an electronic controller or control unit or electronic control module (ECM) that may monitor conditions of engine 10 or an associated vehicle in which engine 10 may be located. Control module 56 may be a single processor, a distributed processor, an electronic equivalent of a processor, or any combination of the aforementioned elements, as well as software, electronic storage, fixed lookup tables and the like. Control module 56 may include a digital or analog circuit. Control module 56 may connect to certain components of engine 10 by wire harness 58, though such connection may be by other means, including a wireless system. For example, control module 56 may connect to and provide control signals to inlet metering valve 52 and to fuel injectors 38.

When engine 10 is operating, combustion in combustion chambers 40 causes the movement of pistons 22, 24, 26, 28, 30, and 32. The movement of pistons 22, 24, 26, 28, 30, and 32 causes movement of connecting rods 34, which are drivingly connected to crankshaft 20, and movement of connecting rods 34 causes rotary movement of crankshaft 20. The angle of rotation of crankshaft 20 is measured by engine 10 to aid in timing of combustion events in engine 10 and for other purposes. The angle of rotation of crankshaft 20 may be measured in a plurality of locations, including a main crank pulley (not shown), an engine flywheel (not shown), an engine camshaft (not shown), or on the camshaft itself. Measurement of crankshaft 20 rotation angle may be made with toothed wheel sensor 62, rotary Hall sensor 64, and by other techniques. A signal representing the angle of rotation of crankshaft 20, also called the crank angle, is transmitted from toothed wheel sensor 62, rotary Hall sensor 64, or other device to control system 18.

Crankshaft 20 drives high-pressure fuel pump 46 and low-pressure fuel pump 50. The action of low-pressure fuel pump 50 pulls fuel from fuel tank 44 and moves the fuel along fuel circuit 42 toward inlet metering valve 52. From inlet metering valve 52, fuel flows downstream along fuel circuit 42 to high-pressure fuel pump 46. High-pressure fuel pump 46 moves the fuel downstream along fuel circuit 42 through outlet check valves 54 toward fuel accumulator or rail 48. Inlet metering valve 52 receives control signals from control system 18 and is operable to block fuel flow to high-pressure fuel pump 46. Inlet metering valve 52 may be a proportional valve or may be an on-off valve that is capable of being rapidly modulated between an open and a closed position to adjust the amount of fluid flowing through the valve.

Fuel pressure sensor 60 is connected with fuel accumulator 48 and is capable of detecting or measuring the fuel pressure in fuel accumulator 48. Fuel pressure sensor 60 sends signals indicative of the fuel pressure in fuel accumulator 48 to control system 18. Fuel accumulator 48 is connected to each fuel injector 38. Control system 18 generates and transmits or provides injection control signals to fuel injectors 38 that determine operating parameters for each fuel injector 38. Such injection control signals may include the length of time fuel injectors 38 operate, also called the on-time; e.g., the length of time a fuel nozzle valve element (not shown) opens and closes. The injection control signals may also include the rate at which the nozzle valve element opens and closes, and a timing of the opening and closing of the nozzle valve element with respect to the angle of crankshaft 20. Thus, the injection control signals control the amount of fuel delivered by each fuel injector 38 and the timing of fuel delivery with respect to a position of a piston in a respective cylinder 36.

Referring to FIG. 2, in an exemplary embodiment fuel injector 38 includes a valve portion 68 for providing fuel by way of fuel injector orifice(s) 66 to combustion chambers 40. Fuel injector 38 also includes a fluid inlet 70, and a drain outlet 72. Valve portion 68 is positioned between fluid inlet 70 and injector orifice(s) 66, and between fluid inlet 70 and drain outlet 72. Valve portion 68 may include an electrically actuated valve portion 74 and a pilot actuated portion 76. Pilot actuated portion 76 of valve portion 68 is positioned between fluid inlet 70 and injector orifice(s) 66. Electrically actuated valve portion 74 is positioned between pilot actuated portion 76 and drain outlet 72. Electrically actuated valve portion 74 is connected to a control system, such as control system 18 or a test control system 108, and receives signals from the control system to cause electrically actuated valve portion 74 to operate.

Electrically actuated valve portion 74 includes an actuator portion 78 and a bias spring 80. Electrically actuated valve portion 74 may be in a variety of configurations, including normally open and normally closed, depending on the configuration of actuator portion 78. In the exemplary embodiment, electrically actuated valve portion 74 is normally closed, maintained by bias spring 80, which prevents fuel flow from pilot actuated portion 76 to drain outlet 72. Pilot actuated portion 76 includes a bias spring 82 that keeps pilot actuated portion 76 biased into a closed position. Actuator portion 78 may be a solenoid or piezoelectric actuator.

Fuel injector 38 operates by receiving an injection control signal generated by the control system. The injection control signal is received by electrically actuated valve portion 74, causing actuator portion 78 to energize, moving a valve plunger (not shown) within electrically actuated valve portion 74 from the closed position shown in FIG. 2 to an open position, which permits a drain fluid to flow from pilot actuated valve portion 76 toward drain outlet 72. The drain fluid flows from a control chamber (not shown) in pilot actuated valve portion 76, which permits pilot actuated valve portion 76 to move from the closed position shown in FIG. 2 to an open position because of a net force against pilot actuated valve portion 76. With pilot actuated valve portion 76 in the open position, fuel is able to flow from fluid inlet 70 to injector orifice(s) 66. The configuration of fuel injector 38, and more particularly valve portion 68, is just one embodiment of many that are able to take advantage of the present disclosure. The principal criterion for any valve embodiment is that drain flow needs to have a definable and consistent relationship to the injected fuel quantity. As long as the relationship between drain flow and injected fuel quantity can be established for a valve portion, then the valve portion is compatible with the system and method of the present disclosure.

Referring to FIG. 2, each fuel injector design or part number may be characterized in a test fixture shown as a simplified schematic and generally indicated at 100. Test fixture 100 may be used to predefine a fuel quantity relationship between fluid flowing through a drain of fuel injector 38 and the amount of fluid delivered through one or more injector orifice(s) 66. Once this relationship is defined for a particular fuel injector design, which may be associated with a part number, then dimensional and configuration controls maintain this relationship, which applies to future fuel injectors produced to the same design. Even though individual fuel injectors need not be tested once a design is qualified, a test fixture similar to test fixture 100 may obtain a limited number of data points for either a sample of fuel injectors or each fuel injector to ensure each fuel injector is operating in accordance with the predefined relationship. Thus, test fixture 100 provides a correlation or fuel quantity relationship between an amount or quantity of drain fuel flow and an amount or quantity of injected fuel flow for the defined fuel injector configuration for one or more operational states. Test fixture 100 includes appropriate mounting hardware (not shown) to secure each fuel injector 38 so that fluid and electrical connections to fuel injector 38 may be made. Test fixture 100 includes a fluid circuit 102, which further includes a drain fuel circuit portion 104 and an injection circuit portion 106. Test fixture 100 also includes a pump 114, an accumulator 116, a reservoir 118, a relief valve 120, and, in the exemplary embodiment, a plurality of flow meters 122.

Fluid circuit 102 extends from reservoir 118. Pump 114 is positioned along fluid circuit 102 downstream from reservoir 118. Pump 114 operates to draw fluid from reservoir 118 and to move fluid through fluid circuit 102. The fluid used in test fixture 100 may be a fuel such as diesel, or may be another test fluid with a viscosity similar to fuel, such as a lubricant, complex hydrocarbon, coolant, or other fluid suitable for pumping under high pressure, e.g., greater than 1,000 bar. Accumulator 116 is positioned along fluid circuit 102 downstream from pump 114. A flow meter 122c may be positioned along fluid circuit 102 downstream from reservoir 116. Fluid circuit 102 also includes a relief circuit portion 124 that connects accumulator 116 with reservoir 118. Relief valve 120 is positioned along relief circuit 124 between accumulator 116 and reservoir 118 and serves to maintain the pressure in accumulator 116 near a fixed or target pressure level. A flow meter 122a is positioned along drain fuel circuit 104, which connects to reservoir 118. A flow meter 122b is positioned along injection circuit portion 106.

Test fixture 100 also includes test control system 108. Test control system 108 may include a test control module 110 and a test wire harness 112. Test control system 108 may send control signals to pump 114 and to a fuel injector 38 being tested and may receive drain flow signals from flow meters 122a, 122b, and 122c.

In order to characterize a fuel injector 38, fuel injector 38 is positioned within test fixture 100. Fluid circuit 102 of test fixture 100 is connected to fluid inlet 70 of fuel injector 38. Drain fuel circuit portion 104 of test fixture 100 is connected to drain outlet 72 of fuel injector 38. Injection circuit portion 106 of test fixture 100 is connected to injector orifice(s) 66 of fuel injector 38. Test control system 108 is connected to actuator portion 78 by way of wire harness 112, which includes a suitable electrical connector for attaching to or interfacing with electric actuation portion 78, though such connection between test control system 108 and actuator portion 78 may be by other techniques, including a wireless transmitter and receiver arrangement. Once fuel injector 38 is connected as described hereinabove, an operator of test fixture 100 may now start a test process of fuel injector 38.

The test process consists of providing a signal from test control system 108 to energize actuator portion 78. When actuator portion 78 is energized, electrically actuated valve portion 74 opens, relieving fuel pressure from a control chamber (not shown) of pilot actuated valve portion 76 through drain fuel circuit portion 104, where the drain fluid flows into reservoir 118. As drain fluid flows through drain fuel circuit portion 104, the flow rate or volume of drain flow may be measured by flow meter 122a. Drain flow may be measured in other ways, such as by using mass meters, ultrasonic meters, or any other suitable method for measuring drain flow. The relief of pressure permits high-pressure fluid to move pilot actuated valve portion 76 to an open position. As pilot actuated valve portion 76 opens, fluid flows from fluid circuit 102 through pilot actuated valve portion 76 and then to injector orifice(s) 66. From injector orifice(s) 66, the fluid flows through flow meter 122b and into reservoir 118. To close pilot actuated valve portion 76, actuator portion 78 may be de-energized, which blocks drain flow from exiting fuel injector 38 through drain outlet 72. Pressure then builds in the control chamber (not shown), and a net force against pilot actuated valve portion 76 forces pilot actuated valve portion 76 to a closed position.

The drain flow signals from flow meters 122a, 122b, and 122c are sent to test control system 108, which calculates the amount of fluid delivered through injector orifice(s) 66 in relationship to the amount of fluid that flows through drain fuel circuit portion 104. Test fixture 100 may use a variety of flow meter configurations. For example, there may be a different number and location of flow meters than shown in FIG. 2 to provide the necessary data to find the fuel quantity relationship between the amount or flow rate of drain fluid flow and the amount or flow rate of fuel flow through the injector orifice(s) 66 during an injection event. A suitable flow meter configuration enables calculation of fluid flow into drain fuel circuit 104 and fluid flow into injection circuit portion 106. Because it only requires two flow meters to perform the required calculations, the positions of the flow meters shown in FIG. 2 should be considered as possible locations for the flow meters.

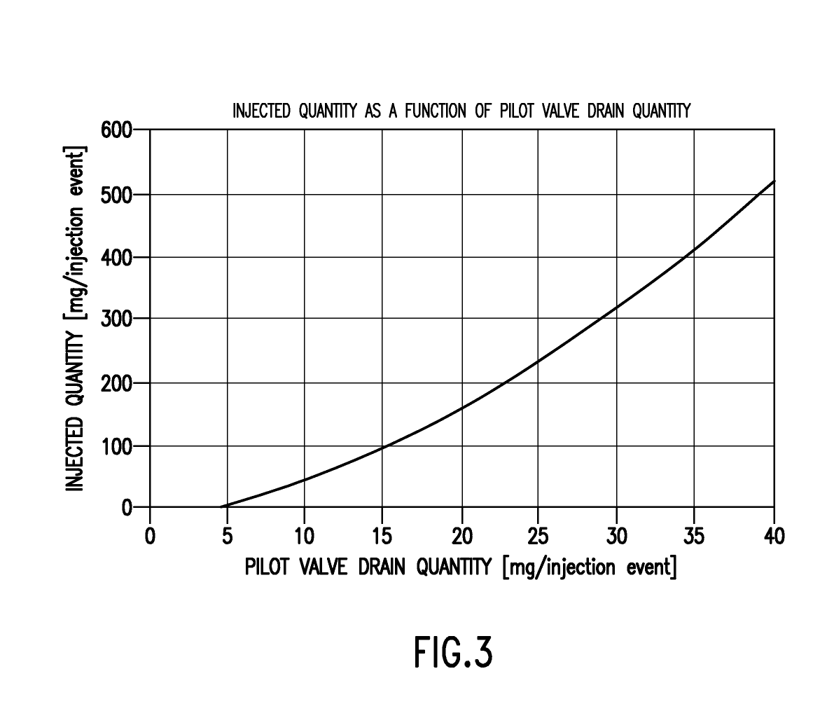

FIG. 3 shows an exemplary graph of data that may be acquired or predefined by test fixture 100, or by other means, such as analysis, for a fuel injector configuration, such as fuel injector 38, showing the correlation or fuel quantity relationship between injected fuel and drain fuel. The horizontal or x-axis is the amount or quantity of fluid drained through drain fuel circuit 104, which may be called the drain fuel flow. The vertical or y-axis is the amount or quantity of fluid that flows through injector orifice(s) 66. As can be seen from FIG. 3, there is a defined relationship between the drain fluid flow and the amount of fluid that flows through injector orifice(s) 66. Once this relationship is defined over a fueling range, which corresponds or correlates to a range of drain fuel flow values for a particular fuel injector 38 design or part number and which forms a model for the particular fuel injector 38 design or part number, the drain fuel flow values and correlated fuel injected values are loaded into the computer-readable medium of control system 18. Control system 18 then uses the model, in the form of a computer-readable instruction, to control the amount of fuel injected by fuel injector 38. While the model in the exemplary embodiment is acquired using a test fixture, the model may be developed using other techniques, such as indirect measurement and analysis.

Turning now to FIG. 4, a first exemplary embodiment in accordance with the present disclosure that may be used in engine 10 is presented. Fuel injector 38 connects to fuel circuit 42 at fluid inlet 70. The engine configuration of FIG. 4 includes a drain fuel circuit portion 39a that connects to drain outlet 72 of fuel injector 38 and to fuel tank 44. A flow-measuring device such as a flow meter 86 is positioned along drain fuel circuit portion 39a between drain outlet 72 and fuel tank 44. Control system 18 connects to actuator portion 78 of fuel injector 38 and to flow meter 86. Control system 18 receives one or more operation state inputs, which may include acceleration, torque, and other vehicle parameters. Using the operation state inputs, control system 18 determines an amount of fuel that each fuel injector 38 needs to inject into an associated combustion chamber 40 during an injection event. Control system 18 then generates and sends or transmits an injection control signal to fuel injector 38, causing a nozzle or needle valve element to open, injecting fuel into combustion chamber 40. Control system 18 monitors, senses, or detects drain fuel flow through drain fuel circuit portion 39a. Once the injection event ends, control system 18 then uses the correlation between drain fuel flow and injected fuel, such as is shown in FIG. 3, to determine the actual amount of fuel injected by fuel injector 38. For example, control system 18 may determine from operation state inputs that a fuel injector 38 needs to inject 100 milligrams of fuel, which, using the fuel quantity relationship shown in FIG. 3, control system 18 determines correlates to a drain fuel flow amount of approximately 16 milligrams. During an injection event, control system 18 monitors the drain fuel flow, which may be by way of drain flow signals from flow meter 86. Once the injection event ends, control system 18 compares the measured drain flow to the anticipated drain flow, or compares the expected fuel injected amount against the amount derived from the drain flow. For example, if control system 18 commands a fuel injector 38 to deliver 100 milligrams of fuel, but the measured drain flow is 14 milligrams rather than the anticipated 16 milligrams, then control system 18 is able to determine that fuel injector 38 needs to be open for a longer period to increase the amount of fuel injected. Control system 18 may either perform this analysis based on drain flow, or based on the estimated fuel injected calculated from the drain flow.

It is also possible to control fueling in applications that justify measuring the drain flow and using the drain flow signal as feedback to control system 18 to terminate an injection event. Such a configuration requires a high-speed flow meter capable of accurately measuring drain flow. In such a configuration, when the drain fuel flow through drain fuel circuit portion 84 reaches approximately 16 milligrams, which in the example shown in FIG. 3 correlates to an estimated 100 milligrams of fuel injected into a combustion chamber, control system 18 de-energizes actuator portion 78, closing electrically actuated valve portion 74. Because there may be some delay in the transmission of the signal to actuator portion 78 and for components to move physically, control system 18 may also consider the amount of fuel delivered between the time the signal is transmitted to actuator portion 78 and the time fuel injection actually ceases, i.e., the nozzle or needle valve element closes. Control system 18 may accommodate that difference by determining or estimating the amount of time delay between sending the control signal and actual termination of fuel flow from the injector orifices and then terminating the signal to actuator portion 78 based on the time delay such that by the time the signal is removed from actuator portion 78 and the time pilot actuated valve portion 76 closes, the total amount of fuel injected will equal the desired amount.

Turning now to FIG. 5, a second exemplary embodiment in accordance with the present disclosure that may be used in engine 10 is presented. Each fuel injector 38 connects to fuel circuit 42 at fluid inlet 70. The engine configuration of FIG. 5 includes a drain fuel circuit portion 39b that connects to each drain outlet 72 of each fuel injector 38 and to fuel tank 44. A flow-measuring device such as a flow meter 90 is positioned along drain fuel circuit portion 39a upstream from fuel tank 44 in a location where the cumulative drain fuel flow from all fuel injectors 38 can flow through flow meter 90. Control system 18 connects to each fuel injector 38 and to flow meter 90. In one embodiment, a plurality of valves (not shown) may select drain flow from one injector 38 at a time, which permits determining whether each valve is operating properly, which permits effective use of a single flow meter. In another embodiment, all injectors may be connected as shown in FIG. 5, but one injector is not operated while the other injectors are operated. By comparing the drain flow from all injectors as compared to the drain flow with one injector turned off, the drain flow from a single injector may be accurately measured. In yet another embodiment, one injector may be connected to a drain flow measurement device and the injected fuel may be estimated from the drain flow. The operation of this fuel injector may then be a “master” injector and used as a relative reference for all other injectors. Many other embodiments exist that use the basic teaching of this disclosure, though some embodiments may cause some intrusion on an engine, and some embodiments may provide more accurate and precise control of individual injectors.

Control system 18 receives one or more operation state inputs, which may include acceleration, torque, and other vehicle parameters. Using the operation state inputs, control system 18 determines an amount of fuel that each fuel injector 38 needs to inject into an associated combustion chamber 40 during an injection event. Control system 18 then generates and sends or transmits an injection control signal to each fuel injector 38, causing a nozzle or needle valve element to open, injecting fuel into an associated combustion chamber 40. Drain fuel flow through drain fuel circuit portion 39b is monitored, sensed or detected by, for example, flow meter 90, which sends drain flow signals indicative of drain fuel flow to control system 18 by way of wire harness 58. Once the injection event is complete, control system 18 is able to use the drain flow to estimate the amount of fuel injected, which permits adjusting a fuel injector on-time for future fuel injection events, as described herein above.

While various embodiments of the disclosure have been shown and described, it is understood that these embodiments are not limited thereto. The embodiments may be changed, modified and further applied by those skilled in the art. Therefore, these embodiments are not limited to the detail shown and described previously, but also include all such changes and modifications.

We claim:

1. A method of controlling an amount of fuel injected by a fuel injector of an internal combustion engine, the method comprising:
providing a fuel quantity relationship between the amount of fuel injected by the fuel injector and an amount of drain fuel flow from the fuel injector;
providing the fuel quantity relationship to a control system of the engine;
determining the amount of drain fuel flow for an injection event; and
controlling the amount of fuel injected by the fuel injector based on the determined drain fuel flow using the fuel quantity relationship.

2. The method of claim 1, wherein the fuel quantity relationship is defined using a test fixture.

3. The method of claim 1, wherein the engine includes a flow meter positioned to measure the drain fuel flow from the fuel injector.

4. The method of claim 3, wherein the flow meter is positioned between the fuel injector and a fuel tank.

5. The method of claim 1, wherein the fuel injector includes a valve actuated when the drain fuel flow from the fuel injector flows into a drain fuel circuit.

6. A method of determining an amount of fuel injected by a fuel injector of an internal combustion engine, the method comprising:
predefining a fuel quantity relationship between an amount of a drain fuel flow of the fuel injector and the corresponding amount of fuel injected by the fuel injector;
providing the fuel quantity relationship to a control system of the engine;
determining the amount of drain fuel flow for an injection event; and
controlling the amount of fuel injected by the fuel injector based on the determined drain fuel flow using the fuel quantity relationship.

7. The method of claim 6, wherein the engine includes a flow meter positioned to measure the drain fuel flow from the fuel injector.

8. The method of claim 7, wherein the flow meter is positioned between the fuel injector and a fuel tank.

9. The method of claim 6, wherein the fuel injector includes a valve actuated when the drain fuel flow from the fuel injector flows into a drain fuel circuit.

10. The method of claim 9, wherein the engine includes a flow meter positioned to measure the drain fuel flow from the fuel injector.

11. The method of claim 10, wherein the flow meter is positioned between the valve and a fuel tank.

12. A system for controlling an amount of fuel injected by a fuel injector of an internal combustion engine, comprising:
a controller adapted to generate an injection control signal and including a non-transitory computer-readable medium;
the non-transitory computer-readable medium including a fuel quantity relationship between the amount of fuel injected by the fuel injector and an amount of drain fuel flow from the fuel injector;
a fuel injector control valve having an open position and a closed position, and adapted to receive the injection control signal;
a flow measuring device adapted to transmit a drain flow signal to the controller that is indicative of the amount of drain fuel flow; and
the controller being adapted to receive the drain flow signal and to transmit the injection control signal to the fuel injector control valve to move the fuel injector control valve from the open position to the closed position when the drain fuel flow correlates to a desired amount of fuel injected based on the fuel quantity relationship.

13. The system of claim 12, wherein fuel quantity relationship is predefined.

14. The system of claim 12, wherein the fuel quantity relationship is defined in a test fixture prior to installation in the engine.

15. The system of claim 12, wherein the flow-measuring device is a flow meter.

16. The system of claim 15, wherein the flow meter is positioned between the injection control valve and a fuel tank.

17. The system of claim 12, wherein the non-transitory computer-readable medium is a computer memory.

18. The system of claim 12, wherein the fuel injector control valve is normally closed.

19. The system of claim 12, wherein the fuel injector control valve is moved between the open and closed positions by a solenoid actuator.

20. The system of claim 12, wherein the fuel quantity relationship is defined for a plurality of operation states of the engine.
